(19) United States
(12) Patent Application Publication
(10) Pub. No.: US 2005/0011873 A1
(43) Pub. Date: Jan. 20, 2005

(54) Microstructures and methods of fabricating

(76) Inventors: Michael J. Withford, Ingleside (AU); David Baer, Epping (AU); Andrew Lee, North Rocks (AU); Judith M. Dawes, Epping (AU)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/851,258

(22) Filed: May 21, 2004

(30) Foreign Application Priority Data
May 22, 2003 (AU) 2003902527

(51) Int. Cl. B23K 26/40

(52) U.S. Cl. 219/121.69

(57) ABSTRACT

A process of making a microstructure, is described. The process comprises the steps of forming a plurality of fillable features in a first material, to form a template; and applying a second material to the template so that the second material at least partially fills at least some of the fillable features in the template so as to form the microstructure, said second material being different from the first material. The process of forming a template uses a laser selected from a picosecond laser, a femtosecond laser and a nanosecond UV laser. The invention includes a photonic crytal made by this process.

### TECHNICAL FIELD

The invention relates to microstructures such as photonic crystals and to processes for making them.

### BACKGROUND ART

There is considerable interest in fabricating periodic sub-micron structures in optical materials, termed photonic crystals, and other microstructures for use in the telecommunication industry. These devices will form the optical equivalent of conventional electronic circuitry with the ultimate aim being the realisation of all-optical computer chips. Photonic crystal microstructures are the precursors to all-optical computer chips and are viewed as forming the basis of next generation telecommunications and computing systems.

Current methods for fabricating photonic crystals, such as colloidal sphere packing and 3-D laser intcrferometry, are suitable for producing generic photonic crystals with simple symmetrical designs but are poorly suited to fabricating the complex designs required of optical circuitry. There are a number of patents covering 3-D, templates fabricated using colloidal packing of small spheres. These templates are subsequently annealed and the interstitial spaces filled with a glass or crystalline material, following which the template is removed. This technique offers a low level of control over the placement of defects and is generally limited to simple designs. This is a disadvantage shared by another commonly used technique, namely 3 and 4 beam laser interferometry. Conventional direct-write laser micro-machining provides for greater versatility in the design of the product, but has the disadvantage that it is limited by the laser spot size (at best 1 micron in diameter) to fabricating novel structures of 1 micron in size. Sub micron features are necessary to see true photonic bandgap effects. Laser methods that rely on local heating of a substrate commonly generate features that are at least 10 microns in diameter.

Full control over the placement of defects in otherwise regular arrays may be attained by using conventional femtosecond laser micro-machining, however, this is slow and hence poorly suited to mass production. Furthermore, the definition of the unit cells in these periodic structures is generally poor.

There is therefore a need for a process for producing photonic crystal devices with precisely positioned arrays that allows for accurate control over the placement of unit cells and defects, as well as a need for fabricating other types of microstructures.

Another disadvantage associated with current photonic crystal structures is the difficulty in coupling light into and out of these devices.

### OBJECTS OF THE INVENTION

An object of the present invention is to overcome at least one of the disadvantages of the prior art. It is another object of the invention to satisfy the aforementioned need. Yet another object is to provide a process for fabricating photonic crystals and other microstructures that may be use in optical circuitry.

### SUMMARY OF INVENTION

In a first aspect of the invention there is provided a process of making a microstructure, comprising the steps of:
forming a plurality of fillable features in a first material, to form a template; and
applying a second material to the template so that the second material at least partially fills at least some of the fillable features in the template so as to form the microstructure, said second material being different from the first material.

The first material may be in the form of a film or a layer, and may comprise a polymer. The polymer may be heat-shrinkable, and the process may comprise the step of heat shrinking the polymer after forming a plurality of fillable features therein. The process may be such that the fillable features formed are equal to or smaller than 10, 9 or 8 microns. The fillable features may be for example holes or cavities or depressions or dips or valleys, and may be cylindrical or tapered cylindrical, or some other shape. The step of forming a plurality of fillable features may use a laser, which may be a picosecond laser, a femtosecond laser or a nanosecond laser. The lasers may be operated below, at or near the threshold power level. Preferably if the laser is a nanosecond laser, it operates in the UV wavelength range. The wavelength of the laser may be set according to the nature of the first material. Femtosecond and picosecond lasers may be operated at a wavelength in the UV, visible or IR wavelength range. The step of forming a template may comprise making a structure having more than one layer, forming a plurality of fillable features in the structure and removing at least one of the layers. The layers may be the same material or they may be different materials. At least one of the layers may be removed physically, by peeling off, or by some other means. At least one of the layers may be a sacrificial layer.

In one embodiment of this invention there is provided a process for making a microstructure, comprising the steps of:
forming a plurality of fillable features in a first material, to form a template having features smaller than 8 microns in diameter; and
applying a second material to the template so that the second material at least partially fills at least some of the fillable features in the template so as to form the microstructure, said second material being different from the first material.

The use of a polymer film or layer enables the preparation of a polymer template with a plurality of periodically arranged features such as a two dimensional array of periodically arranged features (e.g. holes or cavities with diameters in the range of from 0.3 μm to 2 μm, for example) from which photonic crystals may be made with high aspect ratio pillars (i.e. height to width ratio) e.g. between 50:1 and 10:1, 25:1 and 10:1, 20:1 and 10:1, or 15:1 and 10:1, 15:1 and 2:1, such as 50:1, 40:1, 30:1, 25:1, 22:1, 20:1, 18:1, 17:1, 15:1, 12:1, 11:1, 10:1, 9:1, 8;1, 7:1, 6:1, 5:1, 4:1, 3:1 or 2:1 arranged in a two dimensional periodic lattice structure separated by a distance in the range of about the wavelength of light and half the wavelength of light to be introduced into the photonic crystal (this arrangement results in a periodic refractive index variation). The separation of the pillars may be of the order of the wavelength of light to be introduced into the photonic crystal. The cross section of each of the features may be circular or it may be oval or elliptical or elongated or it may be polygonal (for example with between 3 and 50 sides, or between 3 and 40 or 3 and 30 or 3 and 20 or 3 and 10 or 5 and 20 or 5 and 10 or 20 and 50 or 30 and 50 sides, and may have about 3, 4, 5, 6, 7, 8, 9, 10, 11, 12, 14, 16, 18, 20, 25, 30, 35, 40, 45 or 50 sides or more than 50 sides), or it may be an irregular shape. The cross section of each of the features may be may be uniform or substantially uniform in cross section along their length or they may be non uniform. Each of the features may be tapered. The pillars may be a cylindrical shape. The pillars may be uniform or substantially uniform in cross section along their length or they may be non uniform. The pillars may be tapered. One of the advantages of using a polymer template is that it is possible to obtain a feature such as a hole or cavity which has a uniform cross section along its length. This may be a result of a self guiding process of the laser spot.

The process may include one or more of the steps of:
applying a vacuum in order to facilitate penetration of the second material into the fillable features in the template;
solidifying the second material in the template;
at least partially removing the first material;
at least partially replacing the removed first material by a third material that is different to the second material; and
applying a layer of a fourth material to said microstructure.

The step of applying the second material may comprise the use of e-beam deposition, magnetron deposition or sputtering, or it may comprise applying a liquid material to the template which material may at least partially penetrate the fillable features of the template, or it may comprise some other technique. At least partially filling, removing or replacing may refer to filling, removing or replacing between 20 and 100% or between 30 and 95% or between 40 and 90% or between 50 and 90% or between 50 and 100% or between 80 and 100%, or may refer to filling, removing or replacing greater than 20, 30, 40, 50, 60, 70, 80, 90 or 95%, or may refer to filling, removing or replacing about 20, 30,40, 50, 60, 70, 80, 90, 95 or 100%.

The step of applying the second material may be performed so that the second material at least partly covers the template. In this case, solidifying the second material may form a surface layer which is joined to the microstructure. The process may include the step of polishing or abrading the surface layer or the layer of the fourth material.

The microstructure may be a photonic crystal. The microstructure may be capable of acting as a waveguide or it may be capable of acting as some other element of optical circuitry. The film may be located on a substrate, which may comprise a photonic crystal or a precursor thereto or it may comprise some other material. The fillable features may be formed using a laser. The first material may be at least partially removed chemically, electrochemically, mechanically or physically. The first material may be at least partially removed by dissolving it chemically or electrochemically. The fourth material may comprise a photonic crystal or a precursor thereto, or it may comprise some other material.

In one embodiment, the process comprises the steps of:
forming a plurality of fillable features in a first material, to form a template having fillable features smaller than 8 microns in diameter;
applying a second material to the template so that the second material at least partially fills at least some of the fillable features in the template so as to form the microstructure, said second material being different from the first material;
solidifying the second material in the template; and
optionally, at least partially removing the first material.

In another embodiment the process comprises the steps of:
forming a plurality of fillable features in a first material using a femtosecond or a picosecond laser operating in a wavelength range in the UV visible or IR range, to form a template;
applying a second material to the template so that the second material at least partially fills at least some of the fillable features in the template so as to form the microstructure, said second material being different from the first material;
solidifying the second material in the template; and
optionally, at least partially removing the first material..

In another embodiment, the process comprises the steps of:
forming a plurality of fillable features in a first material, to form a template;
applying a second material to the template so that the second material at least partially fills at least some of the fillable features in the template so as to form the microstructure, said second material being different from the first material;
solidifying the second material in the template;
at least partially removing the first material;
at least partially replacing the removed first material by a third material that is different to the second material; and
at least partially removing the second material to leave a microstructure similar in shape to the template.

In this embodiment, the third material may be a photonic material, for example silicon, which is difficult to micromachine directly.

In another embodiment, the template comprises a heat shrinkable material, and the process includes the step of heating the template to a temperature equal to or greater than its heat distortion temperature prior to the step of applying the second material, in order to cause the template to shrink. Alternatively, one or more sections of the template may be selectively heated and caused to shrink using a laser (eg. CO₂ laser), while other portions of the template are left unheated and unshrunk.

In still another embodiment the process comprises the steps of:
applying a film to a substrate;
forming a plurality of holes in the film to form a template;
applying a second material to the template so that the second material at least partially fills at least some of the holes;
at least partially covering the upper surface of the film with the second material to form a surface layer;
solidifying second material; and
dissolving the film.

Dissolving the film may be achieved using an agent that does not dissolve the second material. The substrate may comprise, for example, silicon or germanium. The film may comprise a metal or it may comprise a polymer. The holes may extend through the film or they may extend partly through the film, or some of the holes may extend through the film and others may extend partly through the film. The holes may be of uniform size, and may form a pattern which may comprise a regular array of holes. Alternatively, defects may be introduced into the pattern in order to define a optical circuit. A defect may be for example a different sized hole, or may be an absence of a hole. The second material, after being solidified, may be at least partially in the form of pillars. The pillars may be attached to the substrate or they may be attached to the surface layer or they may be attached to both the surface layer and to the substrate. The pillars may be arranged in a pattern whereby, in combination with the substrate or with the surface layer or with both, they form a photonic crystal. The pattern may be such that the array of pillars comprises one or more channels where there are no pillars, said channels being capable of permitting the passage of light. The pattern may define simple, medium or complex optical circuitry so that the microstructure produced by this embodiment may be capable of acting as a waveguide or as some other element of optical circuitry.

The template may include one or more features which are capable of accepting means to direct light to and/or from a particular region of the microstructure. The one or more features may be slots or they may be holes or they may be some other feature. The process of the first aspect may also comprise the step of locating in the template means to direct light to a particular region of the microstructure, and means to receive light from a particular region of tbe nicrostructure. There may be one or more means to direct light and there may be one or more means to receive light. One or more of to the means to direct light and to receive light may be an optic fibre. Non-conventional fibres such as tapered optical fibres and hollow core optical fibres may also be used. The optic fibre may be located in such a manner that, when the microstructure has been fabricated, the optic fibre is capable of directing light to, and/or receiving light from, a photonic circuit embodied in the microstructure. The step of locating said means may be conducted before the step of applying a second material to the template.

The light may comprise visible light or it may comprise electromagnetic radiation of a wavelength outside the visible range. The light may comprise a plurality of wavelengths. Some of the wavelengths may be within the visible range and some may be outside the visible range, or they may all be within the visible range or they may all be outside the visible range.

In a second aspect of the invention there is provided a microstructure produced by the process of the first aspect of the invention.

In a third aspect of the invention there is provided a layered structure wherein at least one of the layers of said structure comprises a microstructure according to the third aspect of the invention. For example, a structure according to this aspect may comprise a top and a bottom layer, each consisting of a 3-D colloidal photonic crystal structure and a central layer consisting of a microstructure produced by the process. The microstructure may have simple, mcdium or complex optical circuitry inscribed in it. In this example, the top and bottom layer could confine light to the plane of the 2-D photonic crystal layer and the function of the optical circuitry could be performed in the central layer. Another example may be a structure wherein several different microstructures, each produced by the process of the first aspect, are optically isolated from each other by interleaved 3-D colloidal photonic crystal layers.

In a fourth aspect of the invention thcrc is provided the use of a heat shrinkable material in the manufacture of a photonic crystal or of a microstructure suitable for use in an optical computer chip or other optical circuitry. The heat shrinkable material may be a polymer. The heat shrinkable material may be caused to shrink by heating it to a temperature equal to or greater than its heat distortion temperature. Alternatively one or more sections of the heat shrinkable material may be selectively heated and caused to shrink using a laser (eg. CO₂ laser), while other portions of the heat shrinkable material are left unheated and unshnink. The heat shrinkable material may be used for making a template for the manufacture of a photonic crystal or microstructure.

In a fifth aspect of the invention there is provided a heat shrinkable material when used in the manufacture of a photonic crystal or of a microstructure suitable for use in an optical computer chip or other optical circuitry. The heat shrinkable material may be used for making a template for the manufacture of a photonic crystal or microstructure.

In a sixth aspect of the invention there is provided the use of a microstructure according to the present invention in the manufacture of an optical computer chip or other optical circuitry.

In a seventh aspect of the invention there is provided an optical computer chip or other optical circuitry, said chip or circuitry comprising a microstructure according to the present invention.

In an eighth aspect of the invention there is provided a microstructure according to the present invention when used in the manufacture of, or as a component of, an optical computer chip or other optical circuitry.

In a ninth aspect of the invention there is provided a method of using a microstructure according to the present invention for the manufacture of an optical computer chip or other optical circuitry, said method comprising the step of connecting said microstructure to one or more other components using a means capable of transmitting light.

In a tenth aspect of the invention there is provided a system for making a microstructure comprising;
means for forming fillable features in a first material to form a template;
means for applying a second material to the template so that the second material at least partially fills at least some of the fillable features in the template, so as to form the microstructure.

The means for forming may be a laser. The laser or suitable device may be controlled by a computer. The means for applying may employ a casting or a deposition technique or some other suitable technique.

The system may optionally include one or more of the following:
means for applying a vacuum in order to facilitate the penetration of the second material into the fillable features in the template,
means for solidifying the second material,
means for at least partially removing the first material,
means for at least partially replacing the removed first material by a third material, and
means for applying a fourth material to the microstructure.

The means for applying a vacuum may be a vacuum pump or some other suitable means. The means for solidifying may comprise a source of radiation, for example UV radiation, visible light, IR radiation, electron beam or other radiation capable of solidifying the second material, or it may comprise some other means for solidifying the second material. The means for at least partially removing thc first material may comprise chemical, electrochemical, mechanical or physical means and may comprise means for dissolving the first material electrochemically or chemically or by means of a solvent, and may also include means for heating the microstructure or the means for at least partially removing in order to facilitate the at least partially removing. The means for at least partially replacing may comprise means for applying a third material to the microstructure, and may also comprise means for solidifying the third material. The means for solidifying the third material may be the same as or different to the means for solidifying the second material. The means for applying a fourth material may employ a casting or a deposition technique or some other suitable technique, and may be the same as or different from the means for applying the second material. The means for applying the fourth material may comprise means for applying a photonic crystal or a precursor thereto. There may also means for at least partially removing the second material. The means for at least partially removing the second material may be the same as or different from the means for at least partially removing the first material.

In an embodiment, the template comprises a heat shrinkable material, and the system also comprises means for heating the template to a temperature equal to or greater than the heat distortion temperature of said template. Said means may comprise a hot plate or an oven or a laser (eg CO₂ laser) or a source of IR radiation or some other suitable device. Alternatively, the system may comprise a laser (eg CO₂ laser) capable of selectively heating one or more sections of the template to above the heat distortion temperature of the template. The laser may be controlled by a computer.

The system may additionally comprise means for locating in the template means to direct light to a particular region of the microstructure and means to receive light from a particular region of the microstructure. There may be one or more means to direct light and there may be one or more means to receive light. One or more of the means to direct light and to receive light may be an optic fibre. The means for locating may comprise a robotic system and may be controlled by a computer.

### DISCLOSURE OF INVENTION

The processes of the present invention use a stepwise technique whereby easily machined materials are micromachined to form a template on which to either ovcrlay or deposit a second, and possibly a third, material using conventional casting or deposition techniques. This overcomes the difficulty of achieving good resolution when micromachining photonic materials such as silicon, germanium and other crystalline or glassy materials.

Photonic Crystals and Optical Circuitry

A photonic crystal typically has a structure on the scale of half the wavelength of light for which it is designed and is periodic and regularly repeating. A defining characteristic of a photonic crystal is that it displays a photonic band-gap.

A photonic crystal may be composed, for example, of a regular array of pillars of a first material embedded in a second material. The size of the pillars and the distance between the pillars may preferably be about half of the wavelength of the light that is to be used in. conjunction with the photonic crystal. The height of the pillars may be much larger than the width of the pillars, and may be greater than 2 microns, or greater than 3 microns or greater than 4 microns or greater than 5 microns, or it may be between 2 and 20 microns or between 2 and 15 microns or between 3 and 10 microns or between 3 and 8 microns or between 4 and 6 microns. The height may be about 2, 2.5, 3, 3.5, 4, 4.5, 5 or 5.5 microns or it may be greater than 5.5 microns. The diameter of the pillars, which corresponds to the diameter of the fillable features in the template, is commonly less than about 10 microns, and may be less than about 8, 6, 4, 2, or 1 microns or less than about 900, 800, 700, 600, 500, 400, 300, 200, 100 or 50 nm, and may be between about 10 microns and 30 nm or between about 8 microns and 50 nm or between about 5 microns and 100 nm or between about 5 microns and 300 nm or between about 10 microns and 300 nm or between about 8 microns and 300 nm or between about 5 microns and 500 nm or between about 1 and 5 microns or between about 1 micron and about 300 nm or between about 500 nm and 300 nm or between about 1 micron and 500 nm or between about 1 and 10 microns or between about 1 and 8 microns, and may be about 30, 50, 100, 150, 200, 250, 300, 350, 400, 450, 500, 600, 700, 800 or 900 nm or about 1, 2, 3, 4, 5, 6, 7, 8, 9 or 10 microns.

The pillars may be arranged in such a manner that the array comprises one or more channels where there are no pillars, said channels being capable of permitting the passage of light of a wavelength that is blocked by the regular array of the photonic crystal. A diagrammatic representation of a sample array of pillars is shown in FIGS. 1A and 1B, and a photomicrograph of an example is shown in FIG. 3. The channel or channels so defined may act as a wave guide or as some other element of optical circuitry, for example as a component of an optical computer chip. Defects may be introduced into the pattern in order to define a optical circuit. A defect may be a different sized hole, or may be an absence of a hole. For example, theory shows that a single defect of a different size left in the middle of the waveguide structure (ie absence of unit cells), as shown in FIG. 3, may be able to provide resonant filtering.

The photonic crystals of the present invention may be used with light in the IR, visible or UV wavelength range, and the wavelength may be in the range of between about 100 and 4000 nm, or between 150 and 2000 nm, or between 200 and 1000 nm, or between about 100 and 700 or between about 100 and 400 or between about 400 and 700 or between about 400 and 1000 or between about 700 and 1000 nm, and may be about 100, 150, 200, 250, 300, 350, 400, 450, 500, 550, 600, 650, 700, 750, 800, 850, 900, 950 or 1000 nm, or may be less than 100 nm or greater than 1000 nm.

Methods of Micro-Machining

In the processes of the present invention, there may be excellent control over the placement of unit cells. In particular, it may be possible to write a blueprint for any desired optical circuit, which may then be fabricated using the processes of the invention.

In order to produce a usable photonic crystal or optical circuit, the micro-machining errors in position and size of the fillable features of the microstructure should be less than 10 % of the target position, or less than 5%, and may be less than 4% or less than 3% or less than 2% or less than 1%, and may be between 0 and 10% or between 0 and 5% or between 1 and 5% or between 2 and 5% or between 3 and 4% of the target position, or may be about 10, 9, 8, 7, 6, 5, 4, 3, 2, 1 or 0.5% of the target position. The fabrication of nicrostructures should be reproducible, with an error of less than 5%, and the error may be less than 4% or less than 3% or less than 2% or less than 1%, and may be between 0 and 10% or between 0 and 5% or between 1 and 5% or between 2 and 5% or between 3 and 4%, or may be about 10, 9, 8, 7, 6, 5, 4, 3, 2, 1 or 0.5%. These may be for example determined by visual means such as a scanning electron microscope, or through profiling the structure using a profilometer, or by measurement of the photonic band-gap.

A pattern may be initially micro-machined into a thin sheet of polymer or metal. The sheet may then be used as a template for fabricating a microstructure via either a casting or a deposition technique, following which the template may be at least partially removed by chemical, electrochemical, mechanical or physical means. The template may be completely removed. The template may be completely or at least partially removed by dissolving it chemically or electrochemically. For example, a template comprising a polyolefin may be removed using boiling xylene to dissolve the polyolefin.

Micro-machining may be by means a laser, employing techniques based on linear absorption processes or techniques based on non-linear absorption processes, or a photolytically induced laser ablation process or a pyrolitically induced laser ablation, or it may be by means of some other suitable device. For example, a laser (typically a femtosecond laser, although a nanosecond laser may be used in certain circumstances) may be used at sub-threshold power levels, thereby relying on the absorption of multiple photons to initiate material removal and consequently providing better resolution than laser methods relying on localised heating processes. The laser may be operated below, at or near the threshold power level. Preferably if the laser is a nanosecond laser, it operates in the UV wavelength range in order to achieve the small spot sizes required by the invention. Femtosecond and picosecond lasers may be operated at a wavelength in the UV, visible or IR wavelength range. The nanosecond laser may be for example a frequency doubled CVL (copper vapour laser). For example, if the polymer is PETG (polyethyleneterephthalate-glycol), the power of the laser may be between about 10 and 30 mW and may be between about 10 and 20 or between about 20 and 30 or between about 15 and 25 mW, and may be about 10, 15, 20, 25 or 30 mW. The frequency of the laser may be between about 100 and 500 fs, or between about 100 and 400 or between about 100 and 300 or between about 100 and 200 fs, and may be about 100, 150, 200, 250, 300, 350, 400, 450 or 500 fs. The pulse width may be between about 100 and 500 nm, and may be between about 100 and 300 or between about 100 and 200 or between about 200 and 300 or between about 300 and 400 or between about 400 and 500 or between about 200 and 400 or between about 200 and 300 or between about 300 and 500 nm, and may be about 100, 150, 200, 250, 266, 300, 350, 400, 450 or 500 nm. The pulse threshold may be between about 0.5 to 5 Jcm⁻², and may depend on the nature of the first material. The threshold may be between about 0.5 and 4 or about 0.5 and 3 or about 0.5 and 2 or about 0.5 and 1 or between about 1 and 5 or about 2 and 5 or about 3 and 5 or about 4 and 5 or about 1 and 4 or about 1 and 3 or about 1 and 2 or about 2 and 3 Jcm⁻², and may be about 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, 3, 3.2, 3.4, 3.6, 3.8, 4, 4.2, 4.4, 4.6, 4.8 or 5 J/cm⁻².

The laser or other suitable device may be controlled by a computer. Commonly the micro-machining may be accomplished within the space of a few minutes, which enables relatively rapid fabrication of microstructures, suitable for mass production.

One method for achieving the small spot sizes required by the invention involves the formation of features in a structure having more than one layer. The layers may comprise the same material or they may comprise different materials. The sacrificial layer may be for example polyvinyl acetate, polyvinyl alcohol, PETG, PET, polyolefin (e.g. PE, HDPE, LDPE, PP, polymethylpentene) or some other polymer or suitable sacrificial material. Due to the natural spread of the laser pulse, a hole created by the pulse in the structure will be somewhat larger at the top than at the bottom. Thus if the laser pulse is applied to a layer of a first material having one or more sacrificial layers on top, the hole size in the first material (which becomes the template) will be smaller. The sacrificial layer(s) may then be removed physically, by peeling off, or chemically or by some other suitable means.

In the process of preparing a microstructure the step of forming a template comprises making a structure having more than one layer, wherein at least one layer is a sacrificial layer and wherein at least one layer is not a sacrificial layer, forming a plurality of fillable features in the structure, and removing the at least one sacrificial layer.

One potential application of the invention may be fabrication of a 3-D photonic crystal optical chip, whereby a 2-D template is sandwiched between two 3-D is colloidal templates. The interstitial spaces of the 2-D template may for example be filled with a material such as silica, which may be precipitated from solution in said interstitial spaces, and the templates of all three layers dissolved away chemically. In this case the top and bottom generic 3-D photonic crystal structures could confine light to the plane of the 2-D photonic crystal layer, which may have complex optical circuitry inscribed in it. More complex layered structures are also possible, wherein, for example, several different microstructures, each produced by one of the processes of this invention, are optically isolated from each other by interleaved 3-D colloidal photonic crystal layers.

The 2-D template process described in this disclosure is well suited to hybrid configurations, wherein the template includes one or more conventional optic fibres embedded in slots aligning them with the photonic circuit. Other types of optic fibres may also be used, for example tapered optical fibres and hollow core optical fibres. These fibres would remain fixed in place following formation of a microstructure. Light may be supplied to and received from a microstructure according to the invention via these fibres. The processes of the invention may be capable of fabricating many useful and complex structures. By comparison, material packing or deposition methods are limited to simple designs only. Furthermore, the templates used in the present invention may be mass produced by using conventional lithographic techniques.

In an embodiment of this invention, a pattern of fillable features is formed in a heat shrinkable film (comprising, for example, PVC, polyolefin, polystyrene, PET, PETG) using, for example, an ultra-violet wavelength laser, to form a template. The template may then be heated to a temperature equal to or greater than its heat distortion temperature (HDT) following which the template and the spacings between the fillable features may shrink by a factor of up to 3 (e.g. 1 to 3 ). The features in the template may also shrink, in some cases by a factor of up to 5 or more. As a result, structures smaller than otherwise possible using conventional laser processing may be realised. The template may be dissolved, using for example boiling xylene or another suitable solvent, following casting, to leave a 2-D photonic crystal microstructure. Alternatively, one or more sections of the template may be selectively heated and caused to shrink using a laser (eg. CO₂ laser) while other sections of the template are left unheated and unshrunk.

Materials

In order to function as a photonic crystal, the material that comprises the pillars and the material between the pillars must be different. The difference in the refractive indices of the two materials may be greater than 1.5 and may be greater than 1.75 or greater than 2 or greater than 2.2, or greater than 2.4 or greater than 2.6 or greater than 2.8 or greater than 3, and may be between 1.5 and 5 or between 1.75 and 5 or between 2 and 5 or between 2 and 4.5 or between 2.5 and 4, and may be about 1.5, 1.75, 2, 2.2, 2.4, 2.6, 2.8 or 3. The difference is preferably greater than 2.

The pillars of the present invention may comprise a skilled material, and may comprise, for example, silicon or germanium or germanium arsenide, or a polymeric material, for example epoxy resin. These may be deposited in the form of a liquid which may penetrate the fillable features of the template, or they may be deposited using e-beam deposition, magnetron deposition, sputtering or some other suitable method. The material between the pillars in the present invention may be air or some other gas, for example hydrogen, nitrogen, argon or carbon dioxide. Alternatively the material between the pillars may be a liquid, for example a laser dye, or it may be a solid, for example a material doped with a rare earth ion such as erbium or ytterbium. The material may also be some other material which is capable of acting as a laser gain medium.

The basic concept of the invention lends itself well to a template comprising any polymer or metal that is capable of being dissolved chemically or electrochemically. The template according to the present invention may comprise a metal or it may comprise a non-metal for example a polymer. In the case of the embodiment in which the template is raised to a temperature equal to or greater than its heat distortion temperature prior to the step of applying the second material, the template will preferably comprise a heat shrinkable material. Such materials are typically polymers, and may for example comprise PVC, polyolefin, polystyrene, PET (polyethylene terephthalate) or PETG (polyethylene terephthalate glycol). An to advantage of using polymers for the template material is tat they are soluble in a variety of solvents, thereby allowing a broader range of materials to be used as the second material.

Materials that may be used as the second, third and/or fourth materials in the invention may comprise spin-on glass, silica suspended in a curable liquid, InGaAsP, InP, semiconductors, polymeric materials or any of the materials in the following table.

| Material | Refractive index at 2 microns |
|---|---|
| AgBr | 2.30 |
| AgCl | 2.07 |
| Al₂O₃ (Sapphire) | 1.50 |
| AMTIR (GeAsSe glass) | 2.50 |
| BaF₂ | 1.46 |
| CaF₂ | 1.42 |
| CdTe | 2.67 |
| Chalcogenide (AsSeTe glass) | 2.80 |
| Csl | 1.74 |
| Diamond | 2.37 |
| GaAs | 3.33 |
| Ge | 4.00 |
| KBr | 1.53 |
| KRS-5 (thallium bromide iodide) | 2.37 |
| LiF | 1.40 |
| MgAl₂O₄ | 1.66-1.74 |
| | (at 3-5 microns) |
| MgF₂ | 1.35 |
| MgO | 1.75 |
| NaCl | 1.52 |
| Polyethylene (high density) | 1.54 |
| Pyrex | 1.47 |
| Silica | 1.5-1.6 |
| Si | 3.40 |
| SiO₂ (quartz) | 1.40 |
| ZnS (Cleartran) | 2.20 |
| ZnSe | 2.20 |

Advantages

The processes of the present invention enable the fabrication of complex microstructures, unlike templates produced by colloidal packing or other methods embodied in the prior art.

The use of heat shrinkable films, or the use of precise laser micromachining, permits the fabrication of sub-micron structures, a capability that is impossible with conventional direct write and mask imaging laser processing facilities. Conventional direct-write laser micro-machining is limited by the laser spot size (at best 1 micron in diameter) to fabricating novel structures of 1 micron in size. The present invention extends the processing range in polymers of direct write laser micro-machining facilities to less than micron in size. Although laser micromachining has been used extensively in processing polymer films, a laser has not previously been used to process heat shrinkable films for fabricating photonic crystal structures.

### BRIEF DESCRIPTION OF DRAWINGS

The invention will now be described, by way of example, with reference to the accompanying drawings, wherein:

FIG. 1A is a diagrammatic representation of a microstructure according to the present invention, displaying a channel that may be capable of acting as a waveguide, and FIG. 1B is a diagrammatic representation of the same microstructure with the top layer removed to show the channel more clearly;

FIGS. 2A, B and C are a set of electron micrographs at different magnifications, showing a regular array of pillars comprising a photonic crystal, which may be made by a process of the present invention;

FIG. 3 is an electron micrograph of a microstructure according to the present invention, showing an array of pillars with a channel which may permit passage of light;

FIG. 4 is a diagrammatic representation of a process according to the present invention, showing different steps of the process;

FIG. 5 is a diagrammatic representation of another process according to the present invention, wherein a template is caused to shrink by heating the template;

FIG. 6 is a diagrammatic representation of a system for making a microstructure according to the present invention;

FIG. 7 is an electron micrograph of a structure in which a template has been filled with silicon and the template partially removed

FIG. 8a shows a non-shrunk hole array formed in polyolefin film formed using the developed process of example 2;

FIG. 8b shows pillar array formed by taking a cast of the hole array shown in FIG. 8a;

FIG. 9 is a diffraction pattern generated by passing a HeNe laser beam through the pillar array of FIG. 8b;

FIG. 10 shows a sandwiched array formed by casting both sides of a template;

FIG. 11a is a micrograph of small holes (about 400 nm diameter) machined into PETG using a frequency tripled femtosecond laser,

FIG. 11b is an expanded view of one of the holes shown in FIG. 11a;

FIG. 12 is a micrograph of a 2D photonic crystal with a 1 micron period; and

FIG. 13 is an image of a laboratory prototype of an add-drop filter.

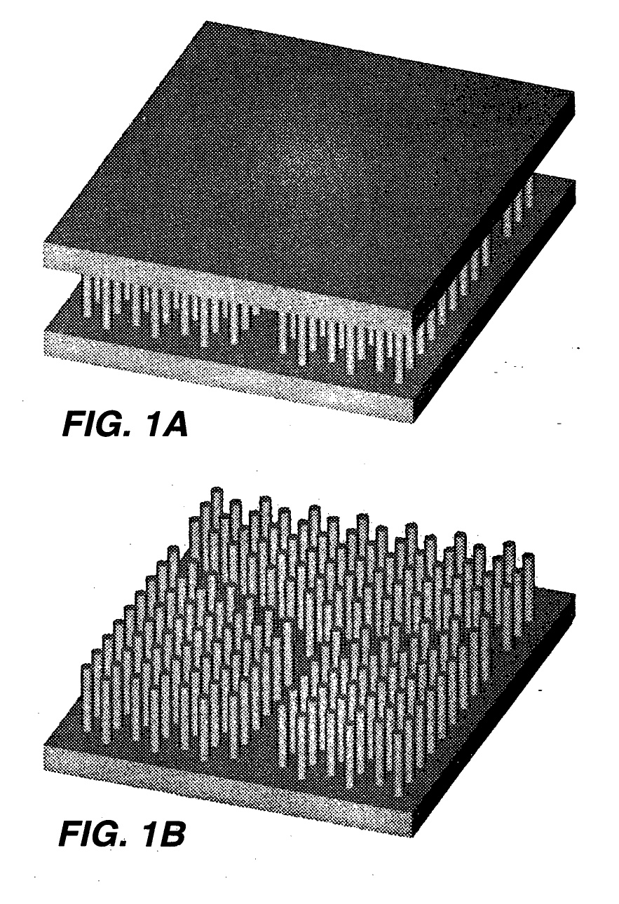

### BEST MODE AND OTHER MODES FOR CARRYING OUT THE INVENTION

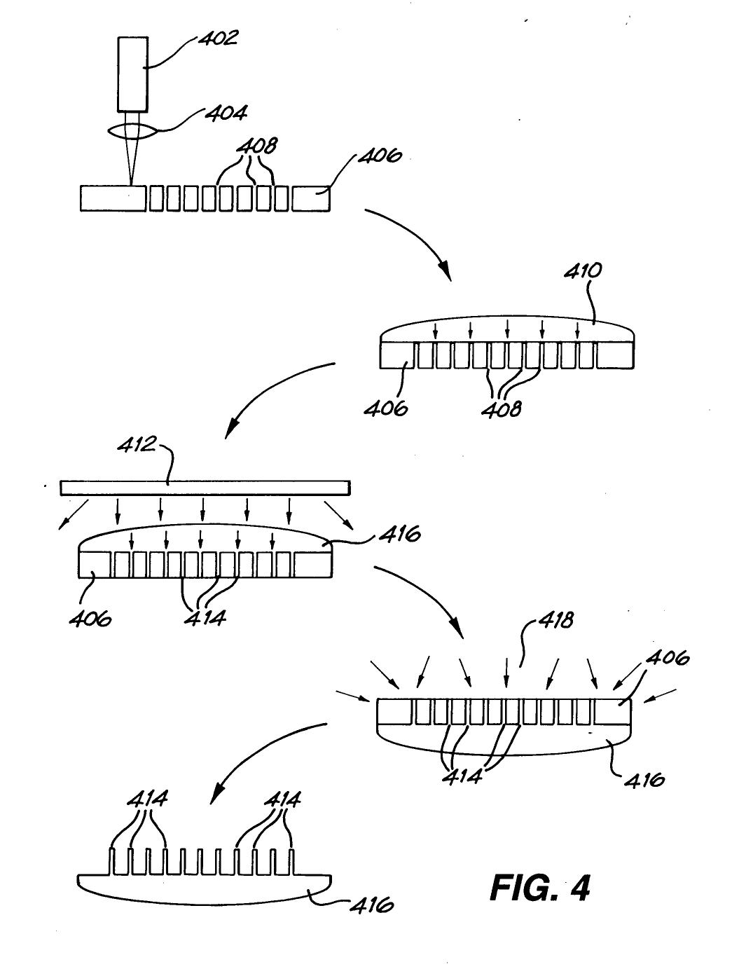

In FIG. 4, UV laser source 402 (which may be a picosecond, femtosecond or a nanosecond laser) provides a beam which is focused using microscope objective 404, thereby ablating portions of polymer film 406 to form holes 408 of diameter in the range 30 nm to 8 μm. Laser source 402 and microscope objective 404 may move in such a manner that holes 408 provide a pattern suitable for making a desired microstructure. Holes 408 may also include features which are capable of accepting means to direct light to and/or from a particular region of the microstructure. The one or more features may be slots or they may be holes or they may be some other feature. Alternatively, laser source 402 and microscope objective 404 may remain stationary and polymer film 406 ay be moved in order to provide the pattern. In the case where it is desired to make a periodic pattern suitable for a photonic crystal the period should be of the order of the light, preferably smaller. The movement of laser source 402 and of microscope objective 404, or of polymer film 406, may be controlled by a computer (not shown).

Once holes 408 haves been completely formed, means to direct light to a particular region of the microstructure, and means to receive light from a particular region of the microstructure, may be located in the template. One or more of the means to direct light and to receive light may be an optic fibre. Next a UV curable material 410 is applied to the surface of polymer film 406. Commonly a vacuum will be applied in order to facilitate the penetration of UV curable material 410 into holes 408. The vacuum may be a partial vacuum and may be less than 500 mbar or it may be less than 200, 100, 50, 40, 30, 20 or 10 mbar or it may be between 500 and 10 mbar or between 400 and 20 mbar or between 300 and 30 mbar or between 200 and 40 mbar or between 100 and 50 mbar or between 100 and 75 mbar, and may be about 500, 400, 300, 200, 200, 100, 90, 80, 70, 60, 50, 40, 30, 20 or 10 mbar, or it may vary, provided that it is sufficient to facilitate penetration of material 410 into the features in the holes 408.

The UV curable material may be an epoxy or some other material. Commonly there will be excess of the UV curable material 410, so that there will be some UV curable material remaining on the top surface of polymer film 406 after the holes 408 have been filled.

After sufficient time to allow UV curable material 410 to substantially fill holes 408, the polymer film 406 is located beneath a source of of UV radiation 412. Under the influence of UV radiation, the UV curable material 410 in holes 408 cures to form pillars 414. Excess UV curable material 410 on the top surface of polymer film may also polymerise under the influence of the UV light to form cured surface layer 416. The time taken to cure the UV curable material may depend on the intensity of the UV radiation, the distance between source 412 and film 406, the nature of UV curable material 410, the thickness of film 406, and other factors, but will commonly be several minutes. The time may be between 1 and 5 minutes, or between 1.5 and 4.5 minutes or between 2 and 4 minutes and may be about 1, 2, 3, 4 or 5 minutes, or it may be less than 1 minute or it may be greater than 5 minutes.

Once curing of the UV curable material 410 is substantially complete, film 406, together with pillars 414 and layer 416, is placed in a solvent 418. Solvent 418 and the conditions of solvent 418 (for example temperature) should be chosen so that it is capable of dissolving film 406, but is incapable of dissolving layer 416 and pillars 414. For example if film 406 comprises a polyolefin and layer 416 and pillars 414 comprise a cured epoxy resin, solvent 418 may be boiling xylene.

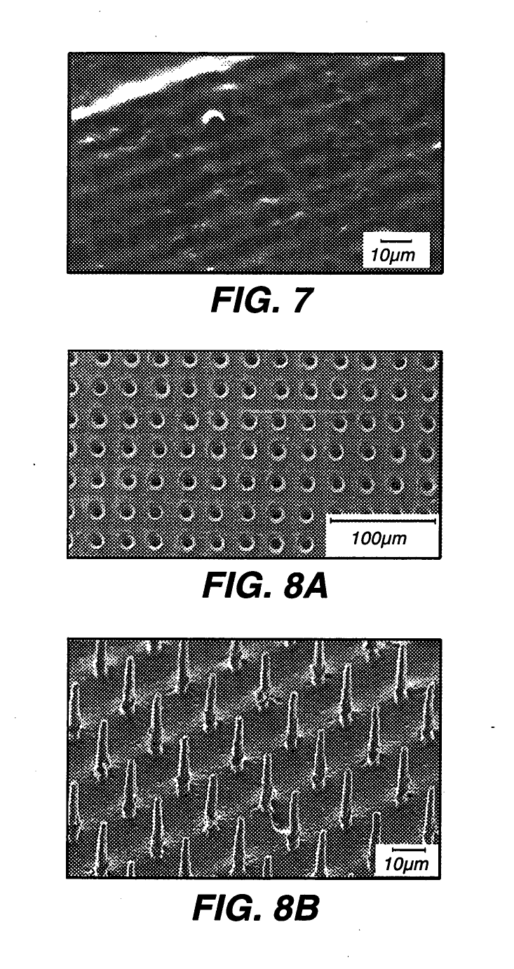

FIG. 7 shows an example of a microstructure in which a template has been filled with silicon, and the template (polyolefin) has been partially removed. The peaks of the silicon pillars may be seen, however the pillars are not fully exposed due to the residual presence of the template.

After film 406 has been substantially dissolved in solvent 418, layer 416 with attached pillars 414 is removed from solvent 418. Optionally layer 416 and pillars 414 may be washed with a solvent that may be the same as or different to solvent 418. They may then be allowed to dry. Layer 416 together with pillars 414 may comprise a microstructure according to the present invention.

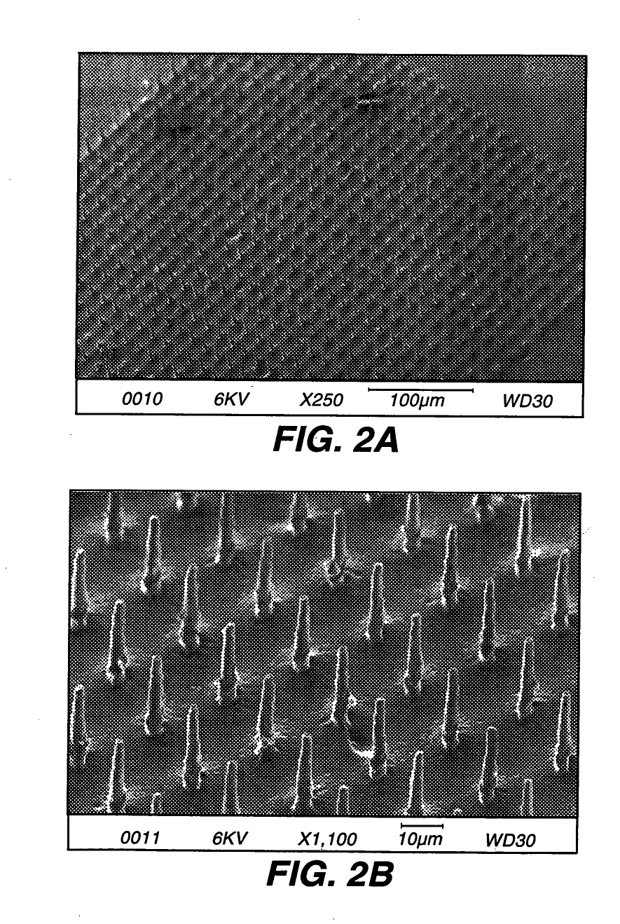

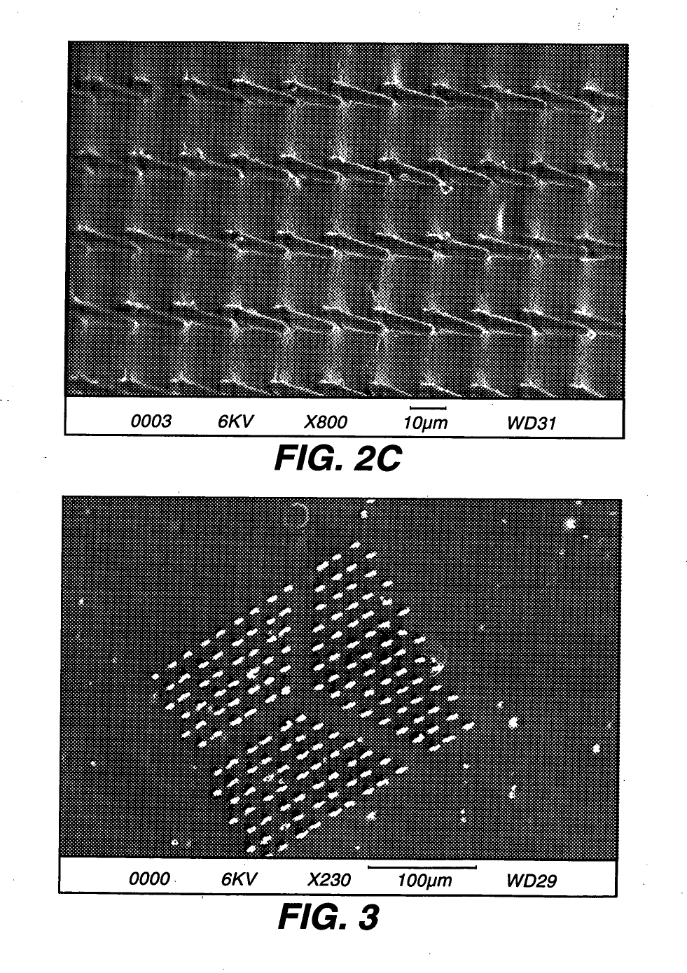

Examples of microstructures that may be made by this process are shown in the electron micrographs of FIGS. 2A, 2B and 2C and FIG. 3. FIGS. 2A, 2B and 2C are electron micrographs of a microstructure comprising a regular (preferably periodic) array of pillars that may be made by the process of the invention, (the refractive index contrast of pillars to air or other material in the photonic crystal is greater than 1 (preferably greater than 1.5, more preferably 2-2.5)). FIG. 3 shows an electron micrograph of a microstructure comprising an array of pillars comprising channels through the array. Those channels may be capable of acting as light guides to permit passage of electromagnetic radiation of an appropriate wavelength in the plane of the array.

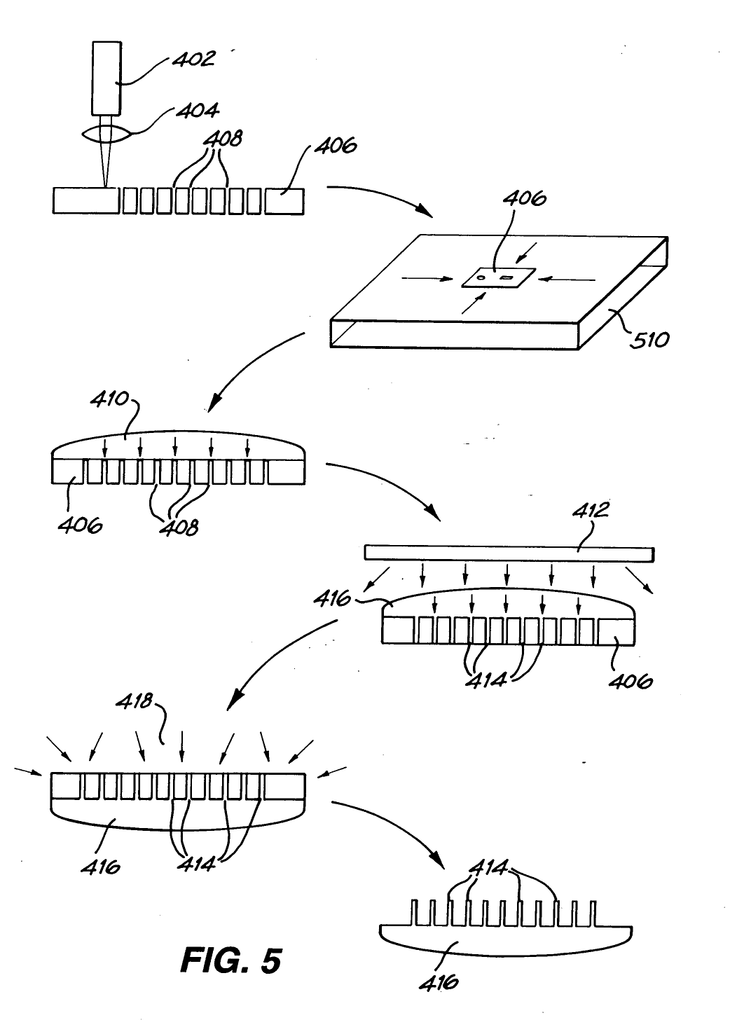

FIG. 5 illustrates another process according to the present invention. In FIG. 5, a pattern of holes 408 is formed in polymer film 406 by means of a laser beam generated by laser source 402 and focused using microscope objective 404, as described for the method detailed above.

Once holes 408 have been completely formed, film 406 is heated. Heating may be effected by placing film 406 on a hotplate 510, as shown in FIG. 5. Alternatively it may be effected by placing it under a heat source or in an oven, or by using some other source of heat. Hotplate 510 is then used to heat film 406 to a temperature equal to or greater than the heat distortion temperature of the material of film 406. The temperature may be the heat distortion temperature of the material of film 406, or it may be higher than the heat distortion temperature of the material of film 406. For a polyolefin, a typical temperature may be between 70 and 100° C. Heating may be performed in an inert atmosphere, for example nitrogen or carbon dioxide, in order to inhibit thermal degradation of the film, Heating may be continued for a time sufficient for the desired degree of shrinkage of film 406 to occur. The time will depend on various factors, including the thickness of film 406, the temperature, the nature of film 406 and other factors, but may typically be several minutes. The time may be between 1 and 5 minutes, or between 1.5 and 4.5 minutes or between 2 and 4 minutes and may be about 1, 2, 3, 4 or 5 minutes, or it may be less than 1 minute or it may be greater than 5 minutes. After film 406 has shrunk to the desired size, it is removed from the source of heat and allowed to return to room temperature. Alternatively, one or more sections of the template may be selectively heated and caused to shrink using a laser (eg. CO₂ laser), while other sections of the template are left unheated and unshrunk.

After holes 408 have been completely formed, and either before or after heat shrinking the template, means to direct light to a particular region of the microstructure, and means to receive light from a particular region of the microstructure, may be located in the template. One or more of the means to direct light and to receive light may be an optic fibre.

A UV curable material 410 is then applied to film 406, allowed to penetrate into holes 408, cured using a UV source 412, and film 406 dissolved in solvent 418 to form a final microstructure, as previously described in the method detailed above.

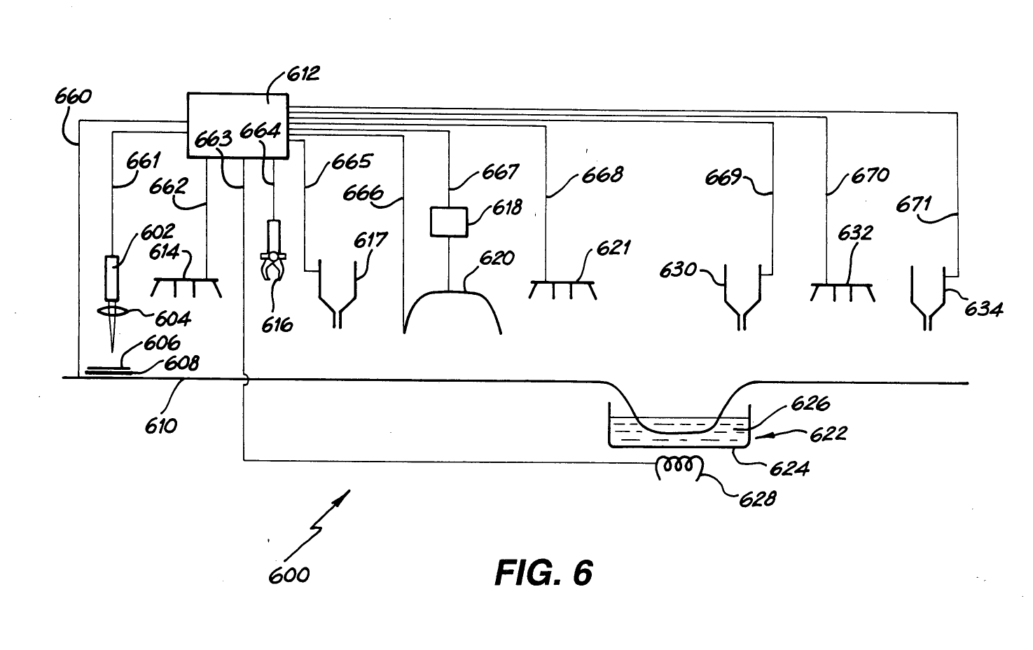

FIG. 6 shows a diagrammatic representation of a system 600 that may be used according to the present invention. In FIG. 6, UV laser source 602 provides a beam which is focussed using microscope objective 604 in order to form features in film 606 to form a template. Film 606 with substrate 608 may be transported through system 600 using a conveyor belt 610 or some other suitable means of conveyance. The movement of source 602, objective 604 and belt 610, as well as the other components of system 600 may be controlled by a computer 612 (which is connected to components of system 600 by means of electrical connections 660 to 671) or by some other suitable control system, or each of these may be controlled by separate computers, or some may be controlled by a computer 612 and some may be controlled by some other means.

A heat source 614 may optionally be provided in order to heat shrink the template formed from film 608. The intensity of the heat source, the distance between the heat source and the template and the rate of transport of the template through the heated zone created by source 614 are such that the template is heated to a temperature equal to or greater than its heat distortion temperature for sufficient time to effect heat shrinkage of the template. There may additionally be means (not shown for reasons of simplicity) to provide an inert atmosphere, for example nitrogen or carbon dioxide, in order to inhibit thermal degradation of the template.

A means 616 may also be provided for locating one or more optic fibres in the template. Means 616 may be a robotic system and may be controlled by computer 612 or by some other means. Means 616 may be used to locate the optic fibres in slots that have been forned in the substrate using laser 602.

A means 617 is provided for applying a second material to the template. Sufficient material should be applied to the substrate so that the features therein are filled with the second material, and preferably so that a surface layer on top of the template is formed. A means to provide vacuum is also provided in order to facilitate penetration of the second material into the features of the template. The means may include a vacuum pump 618 or other means to apply a vacuum, and may also include a vacuum chamber 620 together with a means to transport the template into the chamber. The vacuum may be a partial vacuum and may be less than 500 mbar or it may be less than 200, 100, 50, 40, 30, 20 or 10 mbar or it may be between 500 and 10 mbar or between 400 and 20 mbar or between 300 and 30 mbar or between 200 and 40 mbar or between 100 and 50 mbar or between 100 and 75 mbar, or it may be about 500, 400, 300, 200, 200, 100, 90, 80, 70, 60, 50, 40, 30, 20 or 10 mbar, or it may vary, provided that it is sufficient to facilitate penetration of the second material into the features in the template.

Means 621 is also provided to solidify the second material. This may be a source of radiation, for example UV radiation or heat, or it may be some other means. The means for solidifying will depend on the nature of the second material. For example if the second material is a UV curable epoxy, then means 621 may be a source of UV radiation. The intensity of the UV radiation, the distance between the means 621 and the template and the rate of transport of the template through the irradiated zone created by means 621 are such that the second material receives a sufficient dose of radiation to solidify. Alternatively means 621 may be a heat source to effect evaporation of a solvent in the second material in order to solidify the second material.

Means 622 may then be provided in order to remove the first material. Means 622 may comprise for example a bath 624 containing solvent 626, and may optionally be heated, for example by heating element 628. Conveyor belt 610 may be configured to pass the microstructure through solvent 626. Solvent 626 may be a solvent for the first material and be a non-solvent for the second material. For example if the first material is a polyolefin and the second material is an epoxy then solvent 626 may be xylene. Heating of solvent 626 using heating element 628 may facilitate the dissolution of the first material. Element 628 may be capable of heating solvent 626 to a temperature suitable for solvent 626 to dissolve the first material. That may conveniently be the boiling point of solvent 626, which in the case of xylene is around 140° C.

Means 630 may also be provided to replace the removed first material by a third material. Said means may optionally also include means (not shown for reasons of simplicity) for reorienting the microstructure in order to facilitate the application of the third material to the microstructure, and/or for removing the substrate, and/or for applying a vacuum in order to facilitate penetration of the third material into the microstructure. Sufficient third material may be applied to fill the spaces in the microstructure formerly occupied by the template, or more or less than this amount may be applied. The means for reorienting may comprise a robotic system or it may comprise some different means. If vacuum is applied it may be the same strength of vacuum as the vacuum previously applied or it may be different. It may be applied by a means similar to that used previously to apply vacuum.

A means 632 may be provided for solidifying the third material. This may be a source of radiation, for example UV radiation or heat, or it may be some other means. The means for solidifying will depend on the nature of the third material, and may be the same as or different from the means for solidifying the second material.

A means 634 for applying a layer of a fourth material to the microstructure may also be provided. Said means may be a means for applying a photonic crystal or precursor thereto to the microstructure, or it may be a means for applying some other type of material, for cxample a metal or a polymer to the microstructure. The means may be capable of delivering sufficient of the fourth material to cover the microstructure. The means may also include means (not shown for reasons of simplicity) to solidify the fourth material.

### EXAMPLE 1

A photonic crystal was fabricated as follows. A template was formed in a polyolefin film by combining a laser based ablation process (using a UV, frequency-doubled copper-vapour laser, operating a wavelength of 255 nm) with a computer controlled stage and shutter arrangement. A triangular array which exhibits a band-gap was programmed into the computer. Using an average power of 30 mW and 100 ms exposure time, arrays of holes were formed in the polyolefin film. This constituted the template, which contained approximately 2 μm diameter holes. The template was then sandwiched between two microscope slides, which were spaced using cellulose tape, and the assembly placed on a hotplate at a temperature of 90° C. As a result the template shrunk, with the hole diameter reducing by a factor of five, while the spacing reduced by a factor of two.

The next step involved the filling of the template with a high refractive index material. Germanium was deposited onto the template. After deposition occurred, the template was dissolved using a boiling xylene solution (boiling point about 140° C). The time required for complete removal of the polyolefin template was around 15 minutes. The result was a structure comprised of germanium pillars. Due to the initial design programmed into the computer, this structure acted as a photonic crystal.

A further step which was undertaken to realise a structure with a high refractive index contrast was to deposit silicon onto the structure. This effectively filled the interstitial spaces between the pillars. A final step involved the deposition of additional layers of material onto the upper and lower surfaces to help with waveguiding and confinement in the photonic crystal structure.

### EXAMPLE 2

Method

In this experiment a frequency-doubled copper-vapour laser was used to process a range of different materials in a direct write manner. Frequency doubling was achieved using a beta-barium borate crystal, converting the 510 nm output to 255 nm. The laser was operated at a pulse rate of 10 kHz with a 40 ns pulse duration. Laser ablation using the ultra-violet, frequency-doubled output of these is well known and the characteristics of this laser made it ideal for material processing.

Various polymers including polycarbonate (PC), polyvinylchloride (PVC), polymethylmethacrylate (EMMA), polyolefin and polyethyleneterephthalateglycolate (PETG) were laser-processed. Each has significant absorption in the UV wavelength range, allowing photoablative processes to take place. Due to the copolymer matrix structure of polyolefin it exhibits a high degree of heat-shrinkability, and this property was used to further miniaturise the templates.

The templates were processed using computer controlled x-y stages (Physik Instrumente PI M-155.30; resolution of 1 μm). The laser light was passed through a mechanical shutter and focussed onto the template material using a 20× UV compatible objective lens (OFR: LUM-20×-UVB). An imaging system consisting of a CCD camera and imaging optics was used to monitor the processing of the templates.

When processing the polyolefin film, an additional heating step was used in order to shrink the template and thus to reduce the feature size further. 20 μm thick polyolefin samples were heated on a hot plate to a temperature of 80° C. The final processing step involved taking a cast of the patterned template. Due to the nature of the template, several methods could be employed to fill the structure. In this experiment the method involved using a UV curable epoxy (Norland: NOA 63). The template was then dissolved. Im the case of the polyolefin film, this was performed using a boiling xylene solution.

Results A template consisting of a regular array of holes formed in a polyolefin film is shown in FIG. 8a. The template was formed using an average UV laser power of 50 mW with a 100 ms exposure time per hole. The resultant holes were about 10 μm in diameter and spaced at intervals of about 20 μm. When the polyolefin template was heated at 80° C. for 2 minutes, the hole diameter was reduced by up to a factor of five, while the hole spacing was reduced by a factor of two.

When processing polyolefin films, it was found that there are limits to the density of hole packing which is achievable. This is may be due to cumulative heating of the sample when processing with a nanosecond laser source such as the copper-vapour laser. Evidence of this effect can be seen in FIG. 8a where there is an apparent lip around the circumference of the holes. This is consistent with thermal swelling of the polymer. Furthermore the polyolefin film has a relatively low absorption at 255 nm, thus ablation occurs by both thermal and photoablative mechanisms. For arrays with spacings below 10 μm, it was found that the ability to heat and shrink the array is compromised, and the array may collapse and the holes fill in. This may be due to damage and weakening of the polymer network in the inter-hole regions which is a result of thermal loading when the material is processed at such high packing densities. Thermally induced damage around the holes may also be responsible for the non-linear shrinkage that is observed, causing the holes to shrink at a higher rate than the rest of the template.

An inverse structure as shown in FIG. 8b was formed by filling the template with a UV curable epoxy (NOA 63) and then dissolving the template. The structure comprises of free standing pillars approximately 20 μm high having a base diameter about 4-5 μm tapering to about 2 μm at the top.

The structure mirrors the high level of periodicity in both position and shape in the original template. The tapering and surface roughness of the holes and the pillars are indicative of melt-displacement due to pyrolysis. The aspect ratio was determined as approximately 4.4:1 (pillar height to pillar diameter, pillar diameter was measured as a full-width half-maximum). Analysis of the pillars revealed a mean diameter (full-width half-maximum) of 3.88 μm with a standard deviation of 0.59 μm. The variation in hole diameter may be attributed to minor changes in the laser beam properties (including power fluctuation and beam drift) while machining the holes, and imperfections in the polymer material. Initially this appears to be quite a significant error, however it has been reported that photonic band-gaps are quite robust and remain strong despite significant element misalignment.

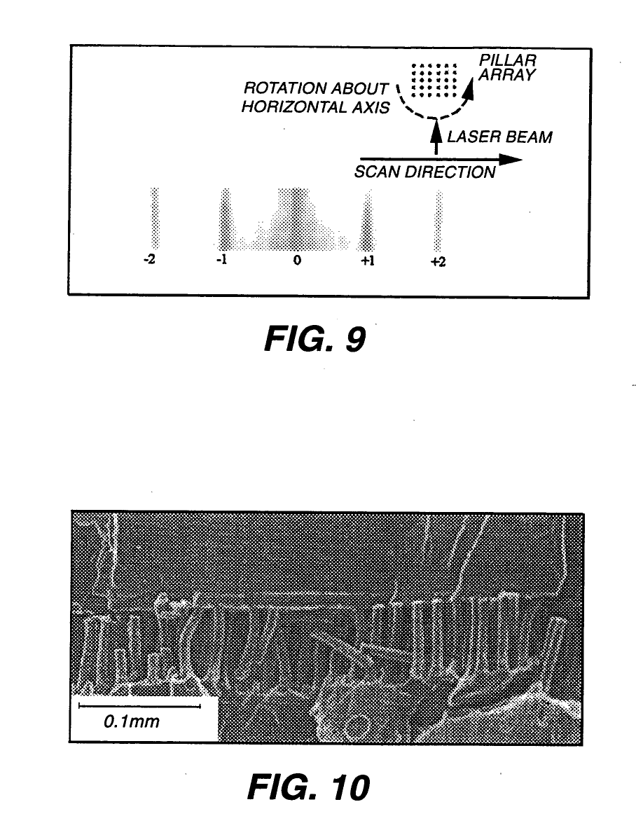

Diffraction experiments were performed using the sample shown in FIG. 8b. A weakly focussed (spot size˜500 μm) HeNe (λ=633 μm) laser beam was used to probe the sample at varying angles of incidence. At normal incidence to the array a regular far-field diffraction pattern was observed with little scattering. A fringe visibility of about 3:1 was observed. A typical diffraction pattern is shown in FIG. 9. The fringe spacings were consistent with the spacing of the array, measured as 20.0 μm±0.7 μm. The laser beam was scanned horizontally across the sample over 2 mm range; throughout the scanning range the fringe spacing varied by only about 3.5%, showing the presence of a highly regular structure. The sample was also probed at other angles of incidence (by rotating the sample about its horizontal plane as shown in the inset of FIG. 9. As the sample was rotated, the fringe spacing changed and therefore the effective feature spacing encountered by the laser beam. When the sample was rotated by 45°, the effective spacing of the array was found to be a factor of 1.41±0.05 of the spacing observed when the beam was at normal incidence to the array. This is consistent with a rotation of a square unit cell by 45°. These results demonstrate that the array has a high degree of regularity.

Deposition of material onto the template allows for the production of slab-waveguide structures. By depositing materials onto both sides of the template and then removing the template, it is possible to produce a slab-waveguide with an embedded photonic crystal. An example of such a structure is shown in FIG. 10. In this case the array was filled on both sides with UV curable epoxy (NOA 63). The pillars show a low level of tapering, high periodicity and high packing density. Thc pillars extended into the structure by 50 unit cells. Broken and bent pillars may be attributed to slight crushing during the cleaving process Such a structure may be used in the confinement of the light to the plane of the photonic crystal. Additionally the ability to differentially laser process one layer while leaving an underlying one unscathed lends itself to processing thin films on supporting substrates and subsequently capping to produce a planar waveguide.

By using a direct write process fill control over the array and placement of defects may be achieved, making it possible to form a wide range of functional photonic crystal based devices such as optical switches, couplers and y-junctions. This technique also has implications in other fields where microstructures are required. Such fields include biological and medical industries where devices such as molecular filters and ultra-high precision flow meters are required.

Initial work have indicated that the template may be adapted to filling techniques such as electron beam deposition, magnetron sputtering, and dipping and evaporative methods. Many different materials which can be deposited into the template including semiconductors, metals, polymers and composites. If the device is to have a high refractive index contrast, materials such amorphous silicon, germanium and chalcogenide may also be deposited into/onto the template.

In order to fabricate true photonic crystals effective at the key telecommunications wavelengths, there is a need to further scale down feature size and increase packing density. To achieve this using the polyolefin films, a move to other non-thermal processing systems is needed. The use of other heat-shrinkable polymers which absorb well at 255 nm is an option, however these have yet to be identified. There is likely to be a level of cumulative heating of the sample when laser processing. A number of alternative, non-thermal techniques exist for processing the template. Such techniques include reactive-ion etching and focussed ion-beam etching. These methods allow for the formation of very small features with a high degree of accuracy. However they have very slow material removal rates (˜1 μm) in comparison to laser based ablation methods (>1 mm/s). Additionally, they do not allow for differential removal of material, in comparison to laser based processing. A more attractive method is to use femotosecond laser based machining.

Conclusion

In conclusion, a method for fabricating novel microstructures has been demonstrated. The direct-write process described allows for the rapid fabrication of templates and prototyping of designs with a high level of control. The use of heat shrinkable templates further enables the fabrication of features significantly smaller than the laser focal spot used in the direct write process. By casting the template it is also possible to generate not only membrane type structures but also surface-relief pillar structures which may form the basis of the next generation of optical devices such as photonic crystals and waveguides.

### EXAMPLE 3

Novel Methods for Fabricating Photonic Crystal Like Structures

One of the most exciting materials to emerge in recent times is the photonic crystal. Various methods for fabricating photonic crystals have been reported. These include bottom-up micro-fabrication methods such as two-photon polymerisation of resins, opal templating, colloidal packing, self-assembly and stacking-micromanipulation processes, and top-down methods such as e-beam lithography, focussed ion beam etching and holography. These methods are capable of forming both two-dimensional (planar) and three-dimensional structures with varying degrees of complexity. However, the methods falling in the first group lack the degree of flexibility required to fabricate complex photonic crystal structures while those in the second have large infrastructure costs.

The recent demonstrations of sub-micron laser machining using ultrafast laser sources opens the way to top-down fabrication of photonic crystals using direct write laser micro-processing. In particular, photonic bandgap structures require periodic variations of refractive index smaller than the wavelength of light. It follows that suitable fabrication methods must be able to produce features sizes half as small again. Typically, unit cells 300-400 nm in size and periods <1 m are reported for photonic bandgaps centred on the 1.5 m telecommunications C-band. These values lie within the range, albeit at the very limit, of features that can be processed using non-linear ultrafast laser micro-processing.

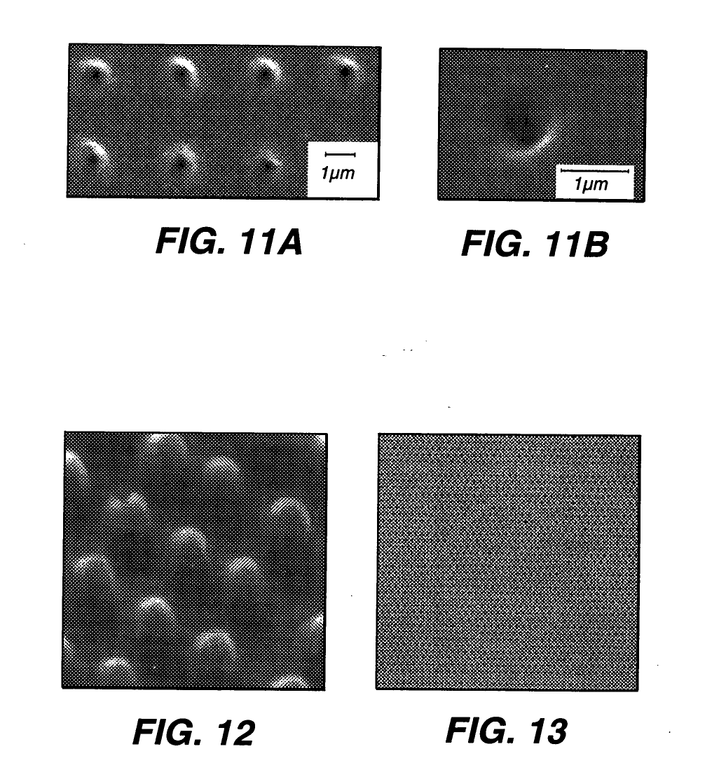

FIG. 11a shows a scanning electron micrograph of an array of holes, about 400 nm in diameter, laser machined in polyethyleneterephthalate-glycolate (PETG) polymer. A higher magnification micrograph of one of these holes is shown in FIG. 11b. The laser used in these experiments was an infra-red (800 μm) Titsapphire femtosecond (150 fs) oscillator/amplifier laser (Spectra Physics Hurricane) operating at a wavelength of to 266 nm. The output power was also attenuated to 20 mW and focussed onto the target via a UV compatible 20× magnification microscope objective. The sample was translated using computer controlled high precision translation stages (Aerotech Fiberalign) beneath a stationary laser beam.

PETG was selected as the target material due to its relatively high absorption coefficient of 266 nm, however, the optical qualities of PETG are not well suited to generating high quality 2-D photonic crystal structures. This problem can be overcome by using the processed film as a template for micro-moulding the inverse structure. FIG. 12 shows a scanning electron micrograph of an inverse structure fabricated using a polymer mould. In this case the mould was overlaid with a UV curable epoxy. After curing the epoxy the original template was dissolved using chloroform. The structure shown in this figure has small pillars which are 400 nm in diameter, reflecting the hole diameter of the original template.

A key feature of direct-write laser micro-processing is that each hole, or unit cell, is individually created. Consequently, defects (ie. the absence of unit cells) can be readily introduced to these 2-D photonic crystal structures. An example of this level of control is well illustrated in FIG. 13, showing a laboratory prototype of an add-drop filter.

1. A process of making a microstructure, comprising the steps of:
forming a plurality of fillable features in a first material, to form a template; and
applying a second material to the template so that the second material at least partially fills at least some of the fillable features in the template so as to form the microstructure, said second material being different from the first material.

2. The process of claim 1 comprising solidifying the second material in the template.

3. The process of claim 1 wherein said forming comprises forming a plurality of fillable features in a polymer, to form a template.

4. The process of claim 3 wherein said forming comprises forming a plurality of fillable features in a heat-shrinkable polymer, to form a template.

5. The process of claim 4 wherein said forming comprises forming a plurality of fillable features in the heat-shrinkable polymer and heat shrinking the polymer.

6. The process of claim 1 wherein said forming comprises ablating the first material with a laser selected from the group consisting of picosecond lasers, femtosecond lasers, and nanosecond UV lasers.

7. The process of claim 6 comprising ablating the first material with the laser operating at a near threshold power level.

8. The process of claim 6 comprising ablating the first material with the nanosecond UV laser.

9. The process of claim 6 comprising ablating the first material with the laser, said laser being selected from the group consisting of picosecond lasers and femtosecond lasers, and the wavelength of the laser being selected from the group consisting of IR wavelengths, visible wavelengths, and UV wavelengths.

10. The process of claim 1 wherein said forming comprises forming a structure having more than one layer, wherein at least one layer is a sacrificial layer and wherein at least one layer is not a sacrificial layer, forming a plurality of fillable features in the structure, and removing the at least one sacrificial layer.

11. The process of claim 1 additionally comprising the step of removing the first material.

12. The process of claim 11 wherein the step of removing comprises dissolving the first material.

13. The process of claim 11 additionally comprising the step of at least partially replacing the removed first material by a third material that is different to the second material.

14. The process of claim 11 additionally comprising the step of at least partially replacing the removed first material by a third material that is different from the second material wherein the difference in refractive indices of the second material and the third material is greater than 1.5.

15. The process of claim 13 additionally comprising the step of at least partially removing the second material.

16. A template for making a microstructure comprising a polymer film having features smaller than 8 microns in diameter.

17. A photonic crystal having features smaller than 8 microns in diameter.

18. The photonic crystal of claim 17 wherein the features are smaller than 1 micron in diameter.

19. A photonic crystal made by a process comprising the steps of:
forming a plurality of features in a first material, to form a template having features smaller than 8 microns in diameter; and
applying a second material to the template so that the second material at least partially fills at least some of the features in the template so as to form the microstructure, said second material being different from the first material.
